(19) United States
(12) Patent Application Publication
(10) Pub. No.: US 2026/0196385 A1
(43) Pub. Date: Jul. 9, 2026

(54) COMMUNICATION CABLE AND WIRE HARNESS

(71) Applicant: YAZAKI CORPORATION, Tokyo (JP)

(72) Inventor: Toshiharu SHIMIZU, Shizuoka (JP)

(73) Assignee: YAZAKI CORPORATION, Tokyo (JP)

(21) Appl. No.: 19/555,386

(22) Filed: Mar. 3, 2026

Related U.S. Application Data
(63) Continuation of application No. PCT/JP2025/001539, filed on Jan. 20, 2025.

(30) Foreign Application Priority Data
Feb. 19, 2024 (JP) 2024-022735

(51) Int. Cl. H01B 11/02; H01B 3/46; H01B 7/00; H01B 7/285

(52) U.S. Cl. CPC H01B 11/02; H01B 3/465; H01B 7/0045; H01B 7/285

(57) ABSTRACT

A communication cable includes: a twisted-pair wire including a pair of wire cores each including a conductor and an insulator covering the conductor; a sheath that covers the twisted-pair wire; and a silicone oil layer disposed between the twisted-pair wire and the sheath. The sheath has a solid form in which a space between an outer peripheral face of the sheath and the silicone oil layer is filled with a material constituting the sheath. The material constituting the sheath contains the same resin as a resin contained in a material constituting the insulator. The silicone oil layer contains silicone oil having a viscosity of 300 CS or more and 1,000 CS or less. An adhesion force between the twisted-pair wire and the sheath satisfies a formula (1).

### CROSS-REFERENCE TO RELATED APPLICATIONS

This is a continuation of International Application No. PCT/JP2025/001539 filed on Jan. 20, 2025, and claims priority from Japanese Patent Application No. 2024-022735 filed on Feb. 19, 2024, the entire content of which is incorporated herein by reference.

### TECHNICAL FIELD

The present disclosure relates to a communication cable and a wire harness.

### BACKGROUND ART

In the related art, a communication cable has been known that includes a twisted-pair wire in which two wire cores are twisted together, and a sheath that is extrusion-molded to cover the twisted-pair wire. Typical molding methods of the sheath include a tube extrusion method in which a sheath is extruded into a tube shape, and a solid extrusion method in which a sheath is extruded to fill a space between an outer peripheral face of the sheath and an outer peripheral face of a twisted-pair wire with a sheath material without a gap (in a so-called solid form) as disclosed in, for example, JP2022-155824A.

In the communication cable manufactured by the tube extrusion method, the sheath is tubular, and thus a gap is generated between the twisted-pair wire and the sheath. As a result, a positional relation between the sheath and the twisted-pair wire tends to change due to an external stress, and transmission characteristics of the communication cable tend to be unstable. On the other hand, the communication cable manufactured by the solid extrusion method does not have the gap described above, and thus the transmission characteristics tend to be more stable than the communication cable manufactured by the tube extrusion method.

It is known that, in the communication cable, by manufacturing an insulator of the wire core and the sheath with the same type of material, a change in dielectric constant or dielectric loss tangent of the entire cable with respect to a change in temperature in a use environment is small, and good transmission characteristics can be obtained. Therefore, the manufacture of the communication cable by the solid extrusion method using the same type of material for the insulator of the wire core and the sheath is being considered.

However, when the communication cable is manufactured by the solid extrusion method using the same type of material for the insulator of the wire core and the sheath, a melting point of the material of the insulator and a melting point of the material of the sheath are approximately the same, and thus the insulator heated by the extrusion-molded sheath is melted, and the insulator and the sheath are likely to stick to each other. When such sticking occurs, it becomes difficult to peel off the sheath from the wire cores during a terminal processing of the communication cable.

As a countermeasure against such sticking, it is conceivable to dispose a powdery release material, such as talc, around the twisted-pair wire. However, in fact, it is difficult to dispose the powdery release material around the twisted-pair wire without a gap.

An object of the present disclosure is to provide a communication cable and a wire harness capable of achieving both stabilization of transmission characteristics and improvement of terminal processability.

### SUMMARY OF INVENTION

In a first aspect of the present disclosure, a communication cable includes:
a twisted-pair wire including a pair of wire cores each including a conductor and an insulator covering the conductor;
a sheath that covers the twisted-pair wire; and
a silicone oil layer disposed between the twisted-pair wire and the sheath, in which
the sheath has a solid form in which a space between an outer peripheral face of the sheath and the silicone oil layer is filled with a material constituting the sheath,
the material constituting the sheath contains the same resin as a resin contained in a material constituting the insulator,
the silicone oil layer contains silicone oil having a viscosity of 300 CS or more and 1,000 CS or less, and
an adhesion force between the twisted-pair wire and the sheath satisfies the following formula (1):

$$5 \leq F \leq A \cdot σ \qquad formula ( 1 )$$

where F represents the adhesion force [N] between the twisted-pair wire and the sheath, A represents a cross sectional area [mm²] of the insulator, and σ represents tensile strength [MPa] of the insulator.

In the present disclosure, the “adhesion force” can be measured in accordance with a test specified in ISO19642-2.

In a second aspect of the present disclosure, a wire harness includes the communication cable.

### BRIEF DESCRIPTION OF DRAWINGS

FIG. 1 is a cross-sectional view illustrating an example of a wire harness including a communication cable according to an embodiment of the present disclosure;

FIG. 2 is a side view illustrating the communication cable illustrated in FIG. 1;

FIG. 3 is a table illustrating structures and materials of communication cables according to Examples 1 to 3 and Comparative Examples 1 to 4;

FIG. 4 is a graph illustrating a characteristic impedance of the communication cable according to Comparative Example 1;

FIG. 5 is a graph illustrating transmission mode conversion characteristics of the communication cable according to Comparative Example 1;

FIG. 6 is a graph illustrating a characteristic impedance of the communication cable according to Example 1;

FIG. 7 is a graph illustrating transmission mode conversion characteristics of the communication cable according to Example 1; and

FIG. 8 is a graph illustrating an adhesion force according to Examples 1 to 3 and Comparative Examples 2 to 4.

### DESCRIPTION OF EMBODIMENTS

Hereinafter, the present disclosure will be described with reference to preferred embodiments. However, the present disclosure is not limited to the embodiments to be described below, and the embodiments can be appropriately changed without departing from the gist of the present disclosure. In the embodiments to be described below, there may be parts in which illustration and description of a part of a configuration are omitted, and it is needless to say that a publicly known or well-known technique is appropriately applied to details of an omitted technique within a range in which no contradiction with contents to be described below would occur.

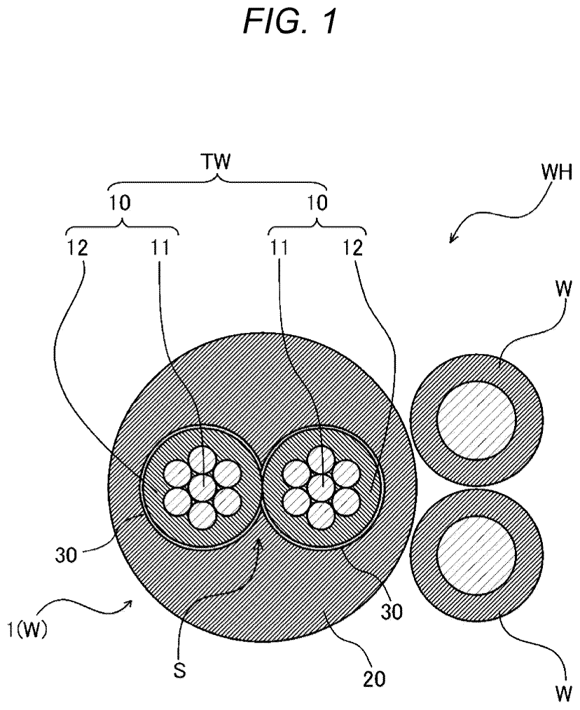

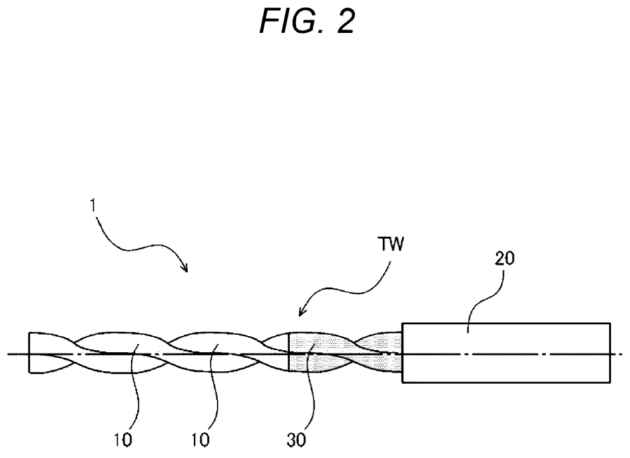

FIG. 1 is a cross-sectional view illustrating an example of a wire harness including a communication cable according to an embodiment of the present disclosure. FIG. 2 is a side view illustrating the communication cable illustrated in FIG. 1.

As illustrated in FIG. 1, a wire harness WH according to the present embodiment includes a plurality of electric wires W. At least one of the plurality of electric wires W (in the present example, one circuit on a left side in FIG. 1) is a communication cable 1 described in detail later.

The wire harness WH may include, for example, connectors (not illustrated) at both end portions of the plurality of electric wires W, or may include a tape (not illustrated) wound around the wire harness WH to bundle the plurality of electric wires W. The wire harness WH may include an exterior component (not illustrated) such as a corrugated tube.

The communication cable 1 includes a twisted-pair wire TW and a sheath 20. As illustrated in FIG. 2, the twisted-pair wire TW has a shape in which two wire cores 10 are twisted together. Each of the wire cores 10 includes a conductor 11 and an insulator 12.

The conductor 11 is made of, for example, a copper alloy. In the present example, as illustrated in FIG. 1, the conductor 11 is constituted by a plurality of strands, but the conductor 11 may be constituted by a single strand. The conductor 11 may be made of pure copper or aluminum, or a face of the conductor 11 may be plated with tin, silver, or the like.

The insulator 12 is a covering member that covers the periphery of the plurality of conductors 11. In the present example, the insulator 12 is made of polypropylene (PP). In the present example, a PP-based resin (resin containing PP as a main component) is used as a material constituting the insulator 12, but another resin such as a polyethylene (PE)-based resin may be used.

The sheath 20 is an insulating member that covers the periphery of the twisted-pair wire TW. As illustrated in FIG. 1, the sheath 20 is provided outside the twisted-pair wire TW in a form (so-called a solid form) in which a space between an outer peripheral face of the sheath 20 and the silicone oil layer 30 is filled with a material constituting the sheath 20. In other words, the sheath 20 is provided in a so-called solid state. In particular, a gap S between the pair of wire cores 10 constituting the twisted-pair wire TW is also filled with the sheath 20. The material constituting the sheath 20 contains the same resin as a resin contained in the material constituting the insulator 12. More specifically, the resin constituting the sheath 20 is a resin having the same main component as the resin constituting the insulator 12. In the present example, the insulator 12 is made of a PP-based resin, and the sheath 20 is also made of a PP-based resin. As an example, the insulator 12 may be made of PP with a small amount of mixture, and the sheath 20 may be made of PP to which a flame retardant is added from the viewpoint of protection performance.

The communication cable 1 further includes the silicone oil layer 30. The silicone oil layer 30 is interposed between the twisted-pair wire TW and the sheath 20. A viscosity of the silicone oil constituting the silicone oil layer 30 is 300 CS or more and 1,000 CS or less. Here, CS is a unit of viscosity referred to as “Centi Stokes”.

In the present example, the resin constituting the insulator 12 and the resin constituting the sheath 20 are resins having slightly different compositions, but having the same main component. In the communication cable 1 of the present example, the silicone oil layer 30 is interposed between the insulator 12 and the sheath 20, and thus even if the insulator 12 is heated by the molded sheath 20 during extrusion molding of the sheath 20, the insulator 12 and the sheath 20 are less likely to stick to each other. The silicone oil layer 30 can be easily disposed uniformly and evenly with respect to the twisted-pair wire TW by using a method of immersing the twisted-pair wire TW in a silicone oil tank or a method of spraying and applying the twisted-pair wire TW to the silicone oil. The silicone oil layer 30 disposed evenly in this manner appropriately prevents the insulator 12 and the sheath 20 from sticking together.

Further, when the viscosity of the silicone oil layer 30 is 300 CS or more and 1,000 CS or less, an adhesion force between the insulator 12 and the sheath 20 can be designed to a value suitable for a terminal processing when the communication cable 1 is actually used. Specifically, in the present example, the adhesion force between the insulator 12 and the sheath 20 is 5 N or more, and the adhesion force is equal to or less than a value (unit: N) of a product of a cross-sectional area (unit: mm²) of the insulator and a tensile strength (unit: MPa) of the insulator. However, the “cross-sectional area of the insulator” is a value obtained by summing cross-sectional areas of the insulators 12 of all the wire cores 10 used in the communication cable 1. That is, in the present example, the “cross-sectional area of the insulator” is a value obtained by summing cross-sectional areas of the insulators 12 of the two wire cores 10. Furthermore, the “adhesion force” can be measured in accordance with a test specified in ISO19642-2. Accordingly, the sheath 20 can be easily peeled off from the insulator 12 during the terminal processing of the communication cable 1, and terminal processability is improved.

Here, when the adhesion force is smaller than 5 N, the twisted-pair wire TW is likely to be displaced so as to slide in an axial direction with respect to the sheath 20 when the sheath 20 is peeled off. As a result, a length (that is, a processing length) by which the twisted-pair wire TW is exposed at a terminal portion of the communication cable 1 changes, and thus it is difficult to appropriately perform the terminal processing. On the other hand, when the adhesion force is larger than “the value (unit: N) of the product of the cross-sectional area (unit: mm²) of the insulator and the tensile strength (unit: MPa) of the insulator”, deformation or breakage of the insulator 12 may occur during the terminal processing. As a result, it is difficult to appropriately perform the terminal processing. That is, it is preferable that the adhesion force between the twisted-pair wire and the sheath satisfies the following formula (1):

$$5 \leq F \leq A \cdot σ \qquad formula ( 1 )$$

where F represents the adhesion force [N] between the twisted-pair wire and the sheath, A represents the cross sectional area [mm²] of the insulator, and σ represents tensile strength [MPa] of the insulator.

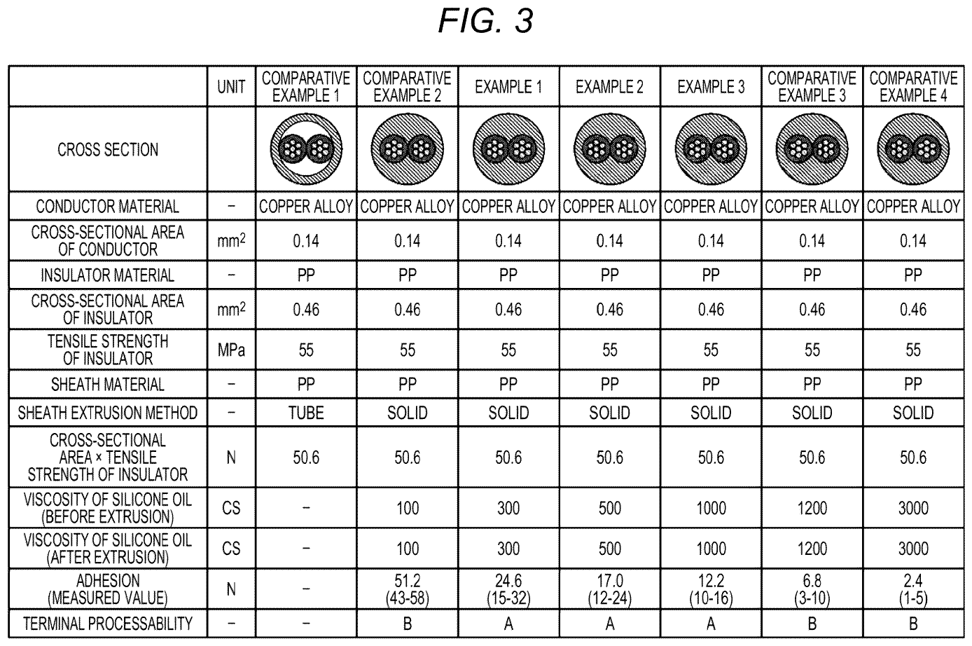

Next, examples and comparative examples of the communication cable 1 will be described. FIG. 3 is a table illustrating structures and materials of communication cables according to Examples 1 to 3 and Comparative Examples 1 to 4. Hereinafter, for convenience of description, “the value (unit: N) of the product of the cross-sectional area (unit: mm²) of the insulator and the tensile strength (unit: MPa) of the insulator” is referred to as “cross-sectional area (mm²) of the insulator ×tensile strength (MPa) of the insulator”.

As illustrated in FIG. 3, in the communication cables according to Examples 1 to 3 and Comparative Examples 1 to 4, a material constituting the conductor 11 of the wire core 10 is a copper alloy, and a cross-sectional area of the conductor 11 of one wire core 10 is 0.14 mm². The insulator 12 of the wire core 10 is made of a resin containing PP as a main component, and the cross-sectional area of the insulator 12 of one wire core is 0.46 mm². The sheath 20 is made of a resin containing PP as a main component.

In Comparative Example 1, the sheath 20 was formed by a tube extrusion method, and in Examples 1 to 3 and Comparative Examples 2 to 4, the sheath 20 was formed by a solid extrusion method. The tensile strength of the insulator 12 is 55 MPa. The value obtained by summing the cross-sectional areas of the insulators 12 of the two wire cores 10 is 0.92 mm² (=0.46×2). Therefore, the “cross-sectional area (mm²) of the insulator×tensile strength (MPa) of the insulator” is 50.6 N in all of Examples 1 to 3 and Comparative Examples 1 to 4.

The viscosity of the silicone oil before extrusion is 100 CS in Comparative Example 2, 300 CS in Example 1, 500 CS in Example 2, 1,000 CS in Example 3, 1,200 CS in Comparative Example 3, and 3,000 CS in Comparative Example 4. The silicone oil is a silicone oil of KF-96 series manufactured by Shin-Etsu Chemical Co., Ltd. However, there is no product having a viscosity of 1,200 CS in the KF-96 series, and thus a mixture of silicone oils having different viscosities from the same series was used in Comparative Example 3. In Comparative Example 1, no silicone oil is used.

The silicone oil is heated in the sheath 20 when the sheath 20 is extrusion-molded. However, a time that the silicone oil receives heat is a short time (for example, about 1 second), and thus the viscosity of the silicone oil does not change. Therefore, the viscosity of the silicone oil after extrusion molding was the same as the viscosity of the silicone oil after extrusion molding in Examples 1 to 3 and Comparative Examples 2 to 4.

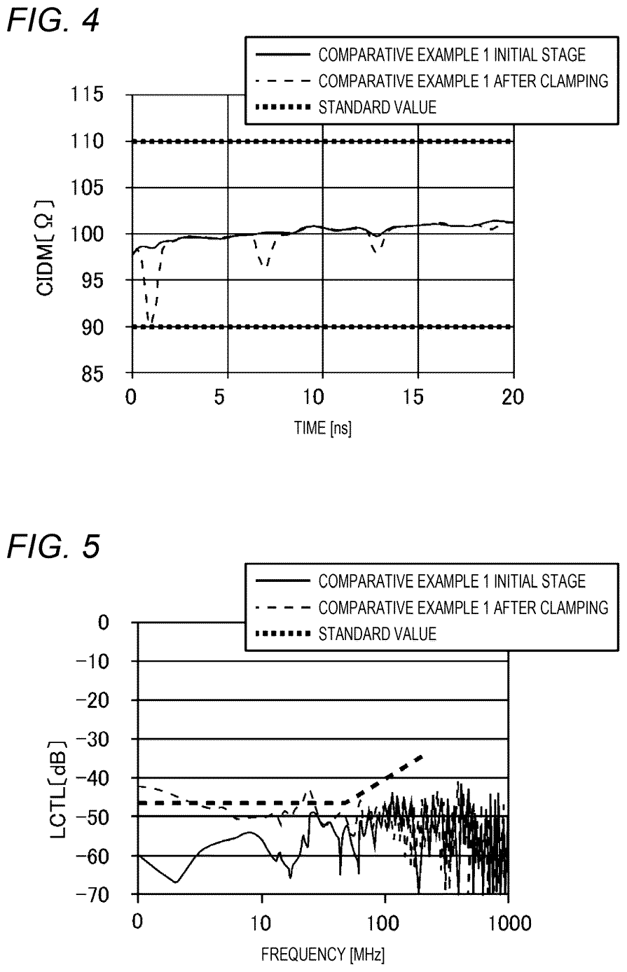

For the communication cable 1 according to Comparative Example 1 and Example 1, a characteristic impedance (characteristic impedance differential mode. Hereinafter, referred to as CIDM) indicating transmission characteristics, and transmission mode conversion characteristics (longitudinal conversion transfer loss. Hereinafter, referred to as LCTL) were measured before clamping (that is, an initial value) and after clamping, respectively. In this measurement, a plastic binding band (specifically, Insulok Tie (registered trademark) for attaching a wire harness for an automatic vehicle to a vehicle body was used as a clamp. The clamp was attached to the communication cable 1 with a binding force (specifically, 10 N or more) such that a position of the clamp does not change during the measurement. The clamps are attached at three positions about 10 cm, about 70 cm, and about 130 cm away from a cable end of the communication cable 1. As a result, as illustrated in FIG. 4, values of CDIM after clamping when values in a horizontal axis (time) are 1 ns, 7 ns, and 13 ns (see a broken line in FIG. 4) were smaller than the initial value of the CIDM at the same time (see a solid line in FIG. 4). A time of about 10 ns illustrated in FIG. 4 corresponds to a length of 1 m of the communication cable 1.

FIG. 4 is a graph illustrating a characteristic impedance of the communication cable 1 according to Comparative Example 1, and FIG. 5 is a graph illustrating transmission mode conversion characteristics of the communication cable according to Comparative Example 1. The graphs of FIGS. 4 and 5 also illustrate standard values to be satisfied.

As illustrated in FIG. 4, in the communication cable 1 according to Comparative Example 1, the initial value of the characteristic impedance was a value in the vicinity of 100 Ω, and was a value within a range of 90Ω or more and 110 Ω or less, which is a standard value. However, the tubular sheath 20 was crushed after clamping, and thus the transmission characteristics were deteriorated. Specifically, the characteristic impedance significantly decreased when the time was 1 ns, 7 ns, and 13 ns. In particular, when the time is 1 ns, the characteristic impedance decreased in the vicinity of a lower limit of the standard value.

As illustrated in FIG. 5, in the communication cable 1 according to Comparative Example 1, the initial value of the transmission mode conversion characteristics was equal to or less than the standard value and was within the range of the standard value. However, after clamping, the value of the transmission mode conversion characteristics was out of the range of the standard value in a frequency band of 4 MHz or less or a frequency band in the vicinity of 30 MHz.

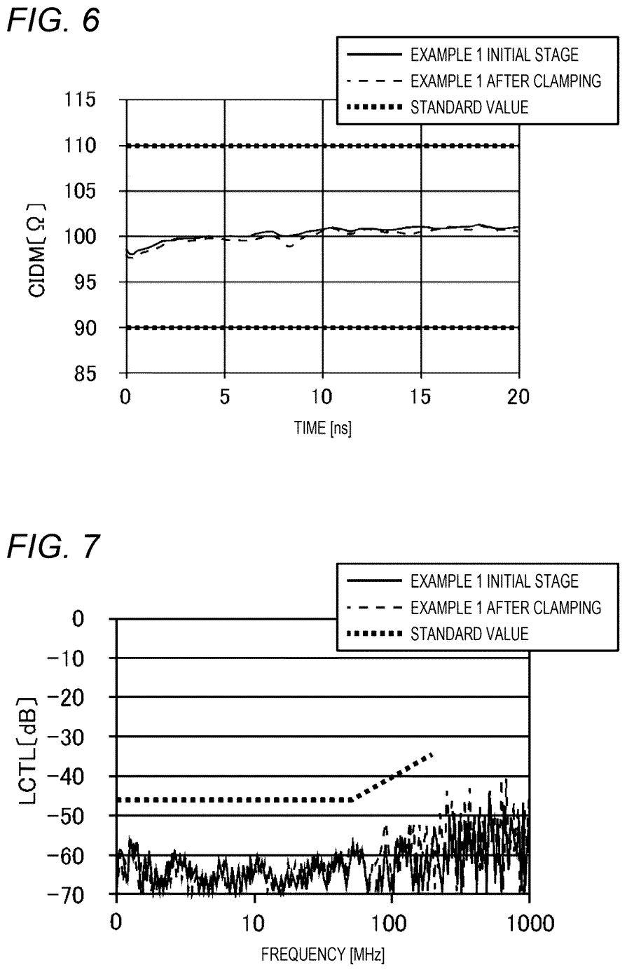

FIG. 6 is a graph illustrating a characteristic impedance of the communication cable 1 according to Example 1, and FIG. 7 is a graph illustrating transmission mode conversion characteristics of the communication cable 1 according to Example 1. The graphs of FIGS. 6 and 7 also illustrate the standard values to be satisfied.

As illustrated in FIG. 6, in the communication cable 1 according to Example 1, the initial value of the characteristic impedance was a value in the vicinity of 100 Ω, and was a value within the range of 90 Ω or more and 110 Ω or less, which is the standard value. After clamping, the characteristic impedance also did not change significantly, and the transmission characteristics were maintained. This is because the sheath 20 is formed in a solid form, and thus the sheath 20 is not crushed by the clamp.

As illustrated in FIG. 7, in the communication cable 1 according to Example 1, the initial value of the transmission mode conversion characteristics was equal to or less than the standard value and was within the range of the standard value. After clamping, the value of the transmission mode conversion characteristics also did not exceed the standard value.

As described above, it was found that the transmission characteristics can be stabilized by forming the sheath 20 in a solid form.

Referring to FIG. 3, in Examples 1 to 3 and Comparative Examples 2 to 4, the adhesion force between the twisted-pair wire TW and the sheath 20 was measured, and the terminal processability was evaluated. The adhesion force was measured in accordance with ISO19642-2. Specifically, the adhesion force was measured by setting an adhesion section between the twisted-pair wire TW and the sheath 20 to 50 mm, hooking the sheath 20 in a hole having a size through which the twisted-pair wire TW passes, and pulling the twisted-pair wire TW. The terminal processability was evaluated based on whether deformation (elongation or the like) or breakage of the insulator 12 occurred when a notch was provided in the sheath 20 and only the sheath 20 was peeled off, and whether the twisted-pair wire TW was displaced together with the peeling of the sheath 20.

Five samples were prepared for each of Examples 1 to 3 and Comparative Examples 2 to 4, and the adhesion force and the terminal processability were evaluated. In FIG. 3, an average value, a maximum value, and a minimum value of the adhesion force are illustrated for the five samples, and the terminal processability is “A” if all of the five samples had good (pass) terminal processability, and is “B” if at least one of the five samples had poor (failure) terminal processability. It is considered that the value of the adhesion force was the minimum value when an application amount of the silicone oil was the largest, and was the maximum value when the application amount of the silicone oil was the smallest. In either sample, the silicone oil does not have too much variation in adhesion force within a range in which an appropriate amount of the silicone oil is applied.

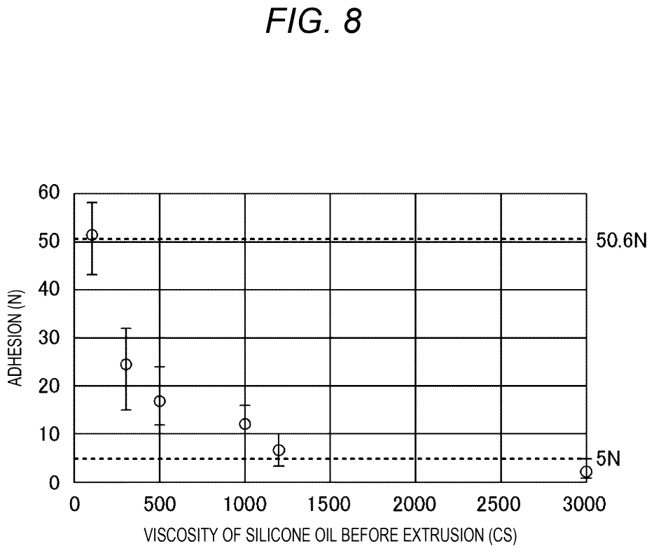

FIG. 8 is a graph illustrating an adhesion force according to Examples 1 to 3 and Comparative Examples 2 to 4.

As illustrated in FIGS. 3 and 8, the adhesion force in Comparative Example 2 had an average value of 51.2 N, a maximum value of 58 N, and a minimum value of 43 N. Among these samples, at least the sample whose adhesion force with the maximum value had poor terminal processability.

The adhesion force in Example 1 had an average value of 24.6 N, a maximum value of 32 N, and a minimum value of 15 N. In Example 1, the terminal processability was good in all the samples.

The adhesion force in Example 2 had an average value of 17.0 N, a maximum value of 24 N, and a minimum value of 12 N. In Example 2, the terminal processability was good in all the samples.

The adhesion force in Example 3 had an average value of 12.2 N, a maximum value of 16 N, and a minimum value of 10 N. In Example 3, the terminal processability was good in all the samples.

The adhesion force in Comparative Example 3 had an average value of 6.8 N, a maximum value of 10 N, and a minimum value of 3 N. Among these samples, at least the sample whose adhesion force with the minimum value had poor terminal processability.

The adhesion force in Comparative Example 4 had an average value of 2.4 N, a maximum value of 5 N, and a minimum value of 1 N. Among these samples, only the sample whose adhesion force with the maximum value had good terminal processability, and the other samples had poor terminal processability.

Here, the terminal processability was good in the sample whose adhesion force (that is, 5 N) with the maximum value in Comparative Example 4, and thus it has become clear that the adhesion force of 5 N or more is preferable. In order to reduce the breakage or excessive elongation of the insulator 12 and improve the terminal processability, the value of the adhesion force is preferably equal to or less than a value (N) of the “cross-sectional area (mm²) of the insulator ×tensile strength (MPa) of the insulator” in terms of a structure of the communication cable 1. In fact, in Comparative Example 2, it has become clear that the terminal processability was poor when the value of the adhesion force exceeds the value calculated by the above formula (that is, 50.6 N).

Furthermore, it has become clear that if the viscosity of the silicone oil is 300 CS or more and 1,000 CS or less before extrusion, and is also 300 CS or more and 1,000 CS or less after extrusion, the adhesion force as described above can be easily obtained.

As described above, the communication cable 1 and the wire harness WH according to the present embodiment include the twisted-pair wire TW and the sheath 20 provided in a solid form. Accordingly, when an external force is applied to the communication cable 1 and the wire harness WH, the transmission characteristics are also less likely to change, and the transmission characteristics can also be stabilized. The communication cable 1 and the wire harness WH include the silicone oil layer 30 made of silicone oil. The silicone oil layer 30 can be easily disposed evenly around the twisted-pair wire TW as compared with a case in which a powdery lubricant is used. The viscosity of the silicone oil is 300 CS or more and 1,000 CS or less, the adhesion force between the twisted-pair wire TW and the sheath 20 is 5 N or more, and is equal to or less than the value (N) of the “cross-sectional area (mm²) of the insulator×tensile strength (MPa) of the insulator”. Accordingly, it is possible to prevent poor terminal processability due to the displacement of the twisted-pair wire TW during the terminal processing due to too low adhesion force. On the other hand, it is possible to prevent poor terminal processability due to the deformation or breakage of the insulator 12 during the terminal processing due to too high adhesion force. Therefore, both the stabilization of transmission characteristics and the improvement of terminal processability are achieved.

The present disclosure is not limited to the embodiments described above, and various modifications can be adopted within the scope of the present disclosure. For example, the present disclosure is not limited to the embodiments described above, and modifications, improvements, and the like can be appropriately made. In addition, materials, shapes, dimensions, numbers, arrangement positions, and the like of the components in the above embodiments are freely selected and are not limited as long as the present disclosure can be implemented.

### Industrial Applicability

The communication cable and the wire harness of the present disclosure can achieve both the stabilization of transmission characteristics and the improvement of terminal processability. The present disclosure having this effect may be used, for example, as a communication cable or a wire harness mounted on an automatic vehicle or the like.

What is claimed is:

1. A communication cable comprising:
a twisted-pair wire including a pair of wire cores each including a conductor and an insulator covering the conductor;
a sheath that covers the twisted-pair wire; and
a silicone oil layer disposed between the twisted-pair wire and the sheath,
wherein the sheath has a solid form in which a space between an outer peripheral face of the sheath and the silicone oil layer is filled with a material constituting the sheath,
wherein the material constituting the sheath contains the same resin as a resin contained in a material constituting the insulator,
wherein the silicone oil layer contains silicone oil having a viscosity of 300 CS or more and 1,000 CS or less, and
wherein an adhesion force between the twisted-pair wire and the sheath satisfies the following formula (1):
$$5 \leq F \leq A \cdot σ \qquad formula ( 1 )$$
where F represents the adhesion force [N] between the twisted-pair wire and the sheath, A represents a cross sectional area [mm²] of the insulator, and σ represents tensile strength [MPa] of the insulator.

2. A wire harness comprising the communication cable according to claim 1.
